(19) United States
(12) Patent Application Publication
(10) Pub. No.: US 2009/0188598 A1
(43) Pub. Date: Jul. 30, 2009

(54) RUN-FLAT PNEUMATIC TIRE

(75) Inventors: Norbert Kendziorra, Garbsen (DE); Ujwal Raj Joshi, Springe (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hanover (DE)

(21) Appl. No.: 12/420,850

(22) Filed: Apr. 9, 2009

(30) Foreign Application Priority Data
Nov. 29, 2006 (DE) 10 2006 056 310.7

(51) Int. Cl. B60C 17/04

(52) U.S. Cl. 152/517

(57) ABSTRACT

A run-flat pneumatic vehicle tire has at least one cross-sectionally crescent-shaped reinforcing profile incorporated in the region of each sidewall and respectively extending at least over a large part of the length of the sidewall. Bead regions with bead cores and bead profiles have at least one bead strip, arranged at least under the bead cores and forming the bead heel. The at least one bead strip, acting together with a rim seat, ensures the seating of the tire on the rim. In order to increase the static friction between the bead heel and the rim, the bead heel is formed of a soft rubber compound with a Shore A hardness of less than 70, at least radially underneath the core, on its outer surface that is facing the rim seat and rests on the rim seat.

### CROSS-REFERENCE TO RELATED APPLICATION

This is a continuation application, under 35 U.S.C. § 120, of copending international application No. PCT/EP2007/060802, filed Oct. 11, 2007, which designated the United States; this application also claims the priority, under 35 U.S.C. § 119, of German patent application No. DE 10 2006 056 310.7, filed Nov. 29, 2006; the prior applications are herewith incorporated by reference in their entirety.

### BACKGROUND OF THE INVENTION

### Field of the Invention

The invention lies in the vehicle tire field. More particularly, the invention pertains to a run-flat pneumatic vehicle tire, comprising a profiled tread, a belt structure, an internal layer which is of air-tight design, an at least single-ply carcass, side walls, each with at least one reinforcing profile which is provided in the region of each side wall, is crescent moon shaped in cross section and extends in each case over at least a large part of the side wall length, bead regions with bead cores and bead profiles, wherein at least one bead strip which is arranged at least underneath the bead cores forms the bead heel which, by interacting with a rim seat face, ensures that the tire is seated on the rim.

Such pneumatic vehicle tires which are self-supporting in the event of a flat have already been known for a relatively long time in various designs. The reinforcing profiles which are installed in the region of the side walls of the tire are embodied in terms of their cross-sectional shape and in terms of various properties of their elastomer mixture in such a way that they are capable of keeping the tire self-supporting over a certain time or over a certain running distance when there is a sudden loss of pressure, that is to say in the event of a flat, permitting the vehicle to continue travelling. A self-supporting tire of the type mentioned above is known, for example, from U.S. Pat. No. 4,261,405 (cf. Japanese patent publication JP 55059005 and German published patent application DE 29 43 654 A1). The tire is provided in the region of each of its side walls with a single-component or multi-component reinforcing profile which is approximately in the shape of a crescent moon in cross section, which is arranged between the internal layer and the carcass layer, and which extends to underneath the belt and into the vicinity of the bead regions.

The side wall reinforcing profile, also referred to as SSR (self-supporting run flat) insert, of a tire which is self-supporting in the event of a flat is generally formed from a hard rubber mixture so that the tire can run, and does not completely collapse, over a certain distance even without air. When a pressure loss occurs, the self-supporting capability of the run-flat tire is achieved by virtue of the fact that the insert which is arranged in the side wall of the tire is loaded in compression, while the carcass which rests against the insert is loaded in tension. This interaction with the carcass and insert makes the tire self-supporting, and the seat of the bead heel on the rim is maintained. However, it has become apparent that the length of the distance over which the seat of the tire is maintained on the rim needs to be improved. This is because the forces acting on the tire in the run-flat mode are extremely high. It is therefore problematic to keep the tire self-supporting in the run-flat mode over a longer distance which is required in the specialist field. On the one hand, the insert material becomes fatigued in the run-flat mode and, on the other hand, the bead heels slip down from the rim seat, with the result that the tire becomes detached from the rim. It is required that the tire should also be reliably seated on the rim over a relatively long distance in the run-flat operating mode, and in addition it is required that the running properties in the normal operating mode should be adversely affected as little as possible, in particular in terms of the spring compression properties, compared to conventional tires without run-flat properties.

It is known to use a bead core with an increased number of core wires in order to obtain an improved seat of the tire, in particular of the bead heel, on the rim. The use of such a bead core requires an increased deployment of material and therefore makes the tire more expensive, while the tire as a whole is made heavier, which has adverse effects on its running properties. It is also known to use so-called chafers, reinforcing member layers having reinforcing members, in the region of the bead. The chafers are intended to make the heel region of the tire more rigid in order to prevent, inter alia, the tire from slipping off from the rim. However, the use of chafers also increases production costs.

### SUMMARY OF THE INVENTION

It is accordingly an object of the invention to provide a run-flat vehicle tire, which overcomes the above-mentioned disadvantages of the heretofore-known devices and methods of this general type and which provides for a cost-effective run-flat tire which remains self-supporting in the run-flat mode over a relatively long distance by virtue of its reliable seat on the rim, and whose spring compression properties are improved.

With the foregoing and other objects in view there is provided, in accordance with the invention, a run-flat pneumatic vehicle tire, comprising:

a profiled tread, a belt structure supporting the profiled tread, an air-tight internal layer, and a carcass formed of at least a single ply;

side walls each formed with at least one reinforcing profile, the at least one reinforcing profile having a crescent moon-shaped cross section and extending in each case over at least a large part of a length of each side wall;

bead regions with a bead core and a bead profile; and at least one bead strip forming a bead heel underneath the bead core, the bead heel having an outer face formed to face towards and rest on a rim seat face of the wheel rim and composed, at least radially underneath the bead core, of a soft rubber mixture having a Shore A hardness of less than 70, for increasing a frictional adhesion between the bead heel and the wheel rim and to ensure, by interacting with the rim seat face, that the tire is seated on the wheel rim.

In other words, the objects of the invention are achieved by virtue of the fact that the bead heel is composed, at least radially underneath the core on its outer face, which faces the rim seat face and rests on the rim seat face, of a soft rubber mixture, which has a Shore A hardness of less than 70, in order to increase the frictional adhesion between the bead heel and the rim.

It is primarily important to the invention that in order to permit a relatively long run-flat distance in the run-flat mode, the rim seat is improved to the effect that the frictional adhesion between the rim and the bead heel is enhanced by the soft rubber mixture. This is because the soft rubber mixture is capable of interacting with the micro roughness of the rim surface so that, as it were, an interlocked connection is formed between the micro roughness of the rim surface and the soft rubber mixture of the bead heel which is seated on the rim surface. The frictional adhesion is improved compared to a previously customary hard rubber mixture (hardness: approximately 78-85 Shore A) in the heel region, with the result that what is referred to as rim roll off—the slipping off of the tire from the rim seat—is delayed. This makes it possible to obtain a longer run-flat distance of the run-flat tire. The use of a soft rubber mixture, which extends in the heel region over the entire axial width of the heel region, also ensures that the spring compression properties are improved despite the thickened side walls of the tire. This is because the soft rubber mixture acts like a cushion or a buffer.

In one preferred embodiment, the soft rubber mixture which is arranged radially on the inside of the bead heel is a rubber bearing layer which extends radially on the inside over the entire axial width of the bead heel region and forms the radially inner surface of the bead heel which comes into contact with the rim seat. In the cross section of the tire, this layer which is composed of a soft rubber mixture has at least an approximately constant thickness of at least approximately 0.5 mm to a maximum of approximately 1.0 mm. One or more layers made of a relatively hard rubber mixture or of a rubber mixture having other properties and optionally reinforcing members can be arranged between the core and the radially inner layer which is composed of a soft rubber mixture and is located radially on the inside underneath the core and spaced apart from it. Such an embodiment of the bead region ensures sufficient strength of the bead region, but the frictional adhesion and the spring compression are also improved.

In another embodiment, the entire bead heel, that is to say the region from the radially inner heel region as far as the core which is located radially above the heel region is composed of the soft rubber mixture. The spring compression properties are particularly good. Reinforcement member layers can additionally be provided in the bead region in order to provide the aimed-at reinforcement.

The above-mentioned objects are achieved with particular efficiency by making the Shore A hardness of the soft rubber mixture approximately 57 in the proposed embodiments.

In accordance with an added feature of the invention, the soft rubber mixture can additionally have rough portions on its face facing the rim seat, which rough portions can improve the frictional adhesion further. In this context, the depth of the roughness is preferably less than 0.5 mm. The rough portions are elevations and/or depressions, which can be geometric patterns in the outer rubber surface.

The arrangement of the soft rubber layer or rubber bearing layer in the heel region is different in various embodiments. In one embodiment, the layer comprised of the soft rubber mixture is arranged only on the radially outer face of the heel region, lying radially underneath the core. In another embodiment, the layer comprised of the soft rubber mixture is arranged on the radially outer face underneath the core and on one side or both sides axially on the inside and/or axially on the outside on the outer heel regions as far as a radial height which is in the region of the apex.

Other features which are considered as characteristic for the invention are set forth in the appended claims.

Although the invention is illustrated and described herein as embodied in a run-flat pneumatic tire, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a partial cross section taken through an SSR run-flat tire;

FIG. 2 shows an enlarged detail of the bead region cross section of the embodiment in FIG. 1;

FIG. 3 shows a cross section through the bead region arranged on a rim and an enlarged detail of the bearing surface between the rim seat and the bead heel;

FIG. 4 shows a cross section through the bead region of another embodiment; and

FIG. 5 shows a cross section through the bead region of a further embodiment.

### DETAILED DESCRIPTION OF THE INVENTION

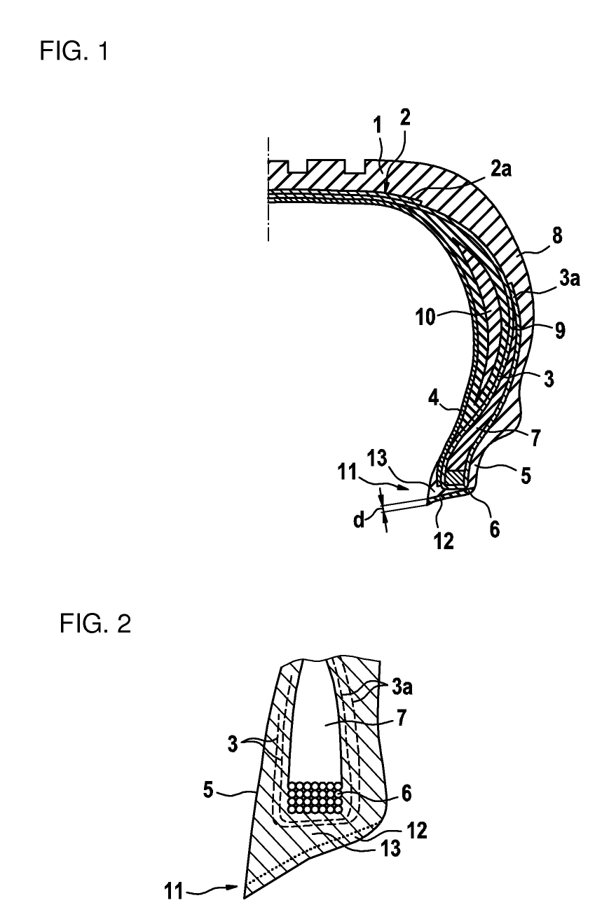

Referring now to the figures of the drawing in detail and first, particularly, to FIG. 1 thereof, there is shown a partial cross section through an SSR radial tire for passenger cars. The primarily important components of the radial tire of the illustrations are as follows: a profiled tread 1, a belt 2 which is composed of two layers 2a in the embodiment shown, an, in particular, single-layer carcass 3, an internal layer 4 which is of largely air-tight design, beads 5 with bead cores 6 and bead core profiles 7 as well as side walls 8 and reinforcing profiles 9, 10 which are approximately crescent moon-shaped. The reinforcing profile 9, 10 is composed here of two different rubber mixtures: an inner profile 10 and an outer profile 9 which surrounds the inner profile 10. However, the reinforcing profile 9, 10 can also be composed of just one rubber mixture. SSR stands for self-supporting run flat tire and denotes pneumatic vehicle tires with run-flat properties owing to reinforced side walls. The two layers 2a of the belt 2 are composed of reinforcement members made of steel cord which are embedded in a rubber mixture and which run parallel to one another within each layer, with the steel cords of one layer 2a being oriented in a crosswise arrangement with respect to the steel cords of the second layer 2a and enclosing in each case an angle between 20° and 35° with the circumferential direction of the tire. The carcass 3 can also be embodied in a conventional and known fashion and therefore have reinforcement threads which are embedded in a rubber mixture, run in a radial direction and are made of a textile material or of a steel cord. The carcass 3 is made to extend from the inside to the outside around the bead cores 6, and their turnups 3a run next to the bead core profiles 7 in the direction of the belt 2. The reinforcing profile 9, 10 which is manufactured from elastomer material, in particular from a rubber mixture, was positioned on the inner layer 4 while the tire was being constructed, and is therefore located between said inner layer 4 and the carcass 3. The thickness of the reinforcing profile 9, 10 decreases both in the direction of the belt 2 and in the direction of the bead 5. In the direction of the belt 2, the reinforcing profile 9 extends under the edge regions of said belt 2. In the direction of the bead 5, the reinforcing profile 9 ends just above the bead core 6. Above the main part of the length of the side wall, the reinforcing profile 7 is given a virtually constant thickness of 6 to 15 mm. The beads 5 have, in their heel region 11, that is to say the radially inner bead region which corresponds to the rim seat of the rim (not illustrated), a circumferential layer 12 made of a soft rubber mixture with a Shore A hardness of approximately 57 at least radially underneath the core 6 on the outer face facing the rim seat face and resting on the rim seat face 15, in order to increase the frictional adhesion between the bead heel 11 and the rim 14. By virtue of the arrangement of the layer 12 which is composed of a soft rubber mixture, the rim seat is improved in order to obtain a longer run-flat distance in the run-flat mode, to the effect that the frictional adhesion between the rim 15 and the bead heel 11 is improved by the soft rubber mixture. The soft rubber mixture interacts with the micro roughness of the rim surface so that, as it were an interlocked connection is formed between the micro roughness of the rim surface and the soft rubber mixture of the bead heel 11 which is seated on the rim surface. The radially inner soft rubber mixture which is arranged on the bead heel 11 is an outer, circumferential rubber bearing layer 12 which at least has a thickness d of 0.5 mm viewed along the cross section of the tire. A relatively hard rubber mixture is arranged as a bead strip 13 between the core 6 and the layer 12 which is composed of soft rubber mixture and is located radially underneath the core 6. Such an embodiment of the bead region ensures sufficient strength of the bead region, but the frictional adhesion and the spring compression are also improved.

FIG. 2 shows a schematic enlargement of the arrangement of the soft rubber layer 12 in FIG. 1 which is arranged radially on the inside, in a way which corresponds to the rim seat face. Identical components are characterized by the same reference numbers.

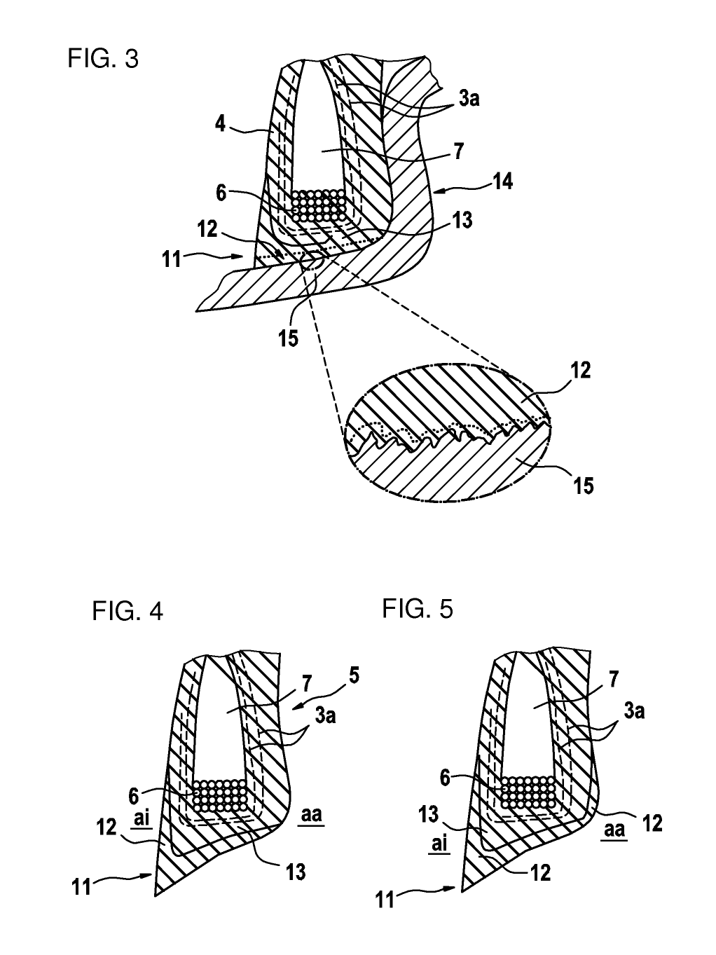

FIG. 3 shows a cross section through the bead region 5, arranged on the rim 14, in FIGS. 1 and 2 and an enlarged detail of the bearing face between the rim seat 15 and the rubber layer 12. In the schematic illustration of a detail, an interlocked connection can be seen between the rim seat surface with micro roughness and the soft rubber layer 12 with the radially inner bead heel region 11.

FIG. 4 shows a different embodiment of the bead region 5, illustrated in cross section, of a passenger car tire. All the illustrations show the right-hand bead region of a tire cross section so that the left of the illustration in the figures is axially on the inside, while the right of the illustration in the figures is axially on the outside. The embodiment of FIG. 4 shows a rubber bearing layer 12 composed of a soft rubber mixture radially underneath the bead strip 13, which mixture extends radially on the inside as a heel region 11 underneath the core 6 and axially inward to a height which is within the height of the core profile 7 and forms the axially inner external face of the bead region.

In the embodiment in FIG. 5, the layer 12 which is composed of a soft rubber mixture is also arranged, in contrast with the embodiment in FIG. 4, on the axially outer side as an external face up to a height which is within the radial height of the core.

1. A run-flat pneumatic vehicle tire, comprising:
a profiled tread;
a belt structure supporting said profiled tread;
an air-tight internal layer;
a carcass formed of at least a single ply;
side walls each formed with at least one reinforcing profile, said at least one reinforcing profile having a crescent moon-shaped cross section and extending in each case over at least a large part of a length of each said side wall;
bead regions with a bead core and a bead profile; and
at least one bead strip forming a bead heel underneath said bead core, said bead heel having an outer face formed to face towards and rest on a rim seat face of the wheel rim and composed, at least radially underneath said bead core, of a soft rubber mixture having a Shore A hardness of less than 70, for increasing a frictional adhesion between said bead heel and the wheel rim and to ensure, by interacting with the rim seat face, that the tire is seated on the wheel rim.

2. The vehicle tire according to claim 1, wherein said soft rubber mixture on an outside of the bead heel region is a rubber layer having a thickness of a minimum of substantially 0.5 mm and a maximum of substantially 2.5 mm viewed along a cross section of the vehicle tire.

3. The vehicle tire according to claim 1, wherein an entire said bead heel is composed of said soft rubber mixture.

4. The vehicle tire according to claim 1, wherein the Shore A hardness of said soft rubber mixture is approximately 57.

5. The vehicle tire according to claim 1, wherein said soft rubber mixture is formed with roughened portions on a face thereof facing the rim seat.

6. The vehicle tire according to claim 5, wherein a depth of a roughness of said roughened portions is less than 0.5 mm.

7. The vehicle tire according to claim 5, wherein said roughened portions are formed by geometric elevation patterns and/or depression patterns on an outer surface of the rubber.

8. The vehicle tire according to claim 2, wherein said rubber layer of the soft rubber mixture is disposed only on a radially outer face, lying radially underneath said bead core.

9. The vehicle tire according to claim 2, wherein said rubber layer of the soft rubber mixture is disposed on a radially outer face underneath said bead core and on one side or both sides axially on the inside and/or axially on the outside on the outer heel regions as far as a radial height which is in the region of an apex.
